(19) United States
(12) Patent Application Publication
(10) Pub. No.: US 2014/0029373 A1
(43) Pub. Date: Jan. 30, 2014

(54) Bowl Assembly

(71) Applicants: Keith Douglas Frerichs, Staten Island, NY (US); Ann Mitchell, Staten Island, NY (US)

(72) Inventors: Keith Douglas Frerichs, Staten Island, NY (US); Ann Mitchell, Staten Island, NY (US)

(21) Appl. No.: 13/949,521

(22) Filed: Jul. 24, 2013

Related U.S. Application Data
(60) Provisional application No. 61/675,899, filed on Jul. 26, 2012.

(51) Int. Cl. B01F 13/00

(52) U.S. Cl. CPC B01F 13/00
USPC 366/129

(57) ABSTRACT

The present invention relates generally to a bowl assembly and in particular, a mixing bowl assembly.

### CROSS REFERENCE TO RELATED APPLICATION

This application claims the benefit U.S. Provisional Application No. 61/675,899, filed Jul. 26, 2012, which is incorporated by reference herein in its entirety.

### FIELD OF THE INVENTION

The present invention relates generally to a bowl assembly and in particular, a mixing bowl assembly.

### SUMMARY OF THE INVENTION

The present invention provides a bowl assembly. In some embodiments, the bowl assembly comprises a mixing bowl having a bottom wall and a peripheral wall; and a substantially vertical handle. The handle is retractably and releasably attached to the outside of the peripheral wall.

In alternate embodiments, the bowl assembly comprises a mixing bowl having a bottom wall and a peripheral wall, wherein the peripheral wall has two diametrically opposed apertures; a scraper member having an edge shaped to substantially conform to the interior shape of the mixing bowl and having an outwardly extending post at each end of the scraper member, the upper portion of which extends through the aperture; wherein the scraper member is capable of extending across substantially the entire interior dimension of the mixing bowl; and a knob rotatably mounted to each post.

In alternate embodiments, the bowl assembly comprises a mixing bowl having a bottom wall and a peripheral wall, wherein the peripheral wall has two diametrically opposed apertures; a substantially vertical handle, wherein the handle is retractably and releasably attached to the outside of the peripheral wall; and a scraper member having an edge shaped to substantially conform to the interior shape of the mixing bowl and having an outwardly extending post at each end of the scraper member the upper portion of which extends through the aperture; wherein the scraper member is capable of extending across substantially the entire interior dimension of the mixing bowl; and a knob rotatably mounted to each post.

In alternate embodiments, the bowl assembly comprises a mixing bowl having a bottom wall and a peripheral wall, wherein the peripheral wall has two diametrically opposed apertures; a scraper member having an edge shaped to substantially conform to the interior shape of the mixing bowl and having an outwardly extending post at each end of the scraper member, the upper portion of which extends through the aperture; wherein the scraper member is capable of extending across substantially the entire interior dimension of the mixing bowl; and a motor means coupled to the post of the scraper member for rotation of the scraper member.

In alternate embodiments, the bowl assembly comprises a mixing bowl having a bottom wall and a peripheral wall, wherein the peripheral wall has two diametrically opposed apertures; a substantially vertical handle, wherein the handle is retractably and releasably attached to the outside of the peripheral wall; and a scraper member having an edge shaped to substantially conform to the interior shape of the mixing bowl and having an outwardly extending post at each end of the scraper member the upper portion of which extends through the aperture; wherein the scraper member is capable of extending across substantially the entire interior dimension of the mixing bowl; and a motor means coupled to the post of the scraper member for rotation of the scraper member.

In some embodiments, the knob is releasably mounted to each post. In other embodiments, the knob is mounted to each post via glue.

In some embodiments, the knob is substantially circular in shape. In other embodiments, the knob is ergonomically shaped.

In some embodiments, the motor means is rigidly attached to the post of the scraper member. In other embodiments, the motor means is coupled to the post of the scraper member through gears.

In some embodiments, the aperture is circular in shape.

In some embodiments, the post is circular in shape.

In some embodiments, the peripheral wall has a vertical lip to position the scraper member within the interior of the mixing bowl.

In some embodiments, the bowl assembly further comprises a lid.

In some embodiments, the mixing bowl comprises a resilient material.

In some embodiments, the handle comprises a resilient material.

In some embodiments, the scraper member comprises a resilient material.

In some embodiments, the knob comprises a resilient material.

In some embodiments, the resilient material is selected from the group consisting of metal, plastic and glass. In preferred embodiments, the resilient material is plastic.

### BRIEF DESCRIPTION OF THE FIGURES

FIG. 1 is a top perspective view of a bowl assembly according to an embodiment of the present invention.

FIG. 2 is a bottom perspective view thereof.

FIG. 3 is a side view thereof (opposing side is mirror image).

FIG. 4 is a cut away side view showing the inside thereof.

FIG. 5 is a side view thereof (opposing side is mirror image).

FIG. 6 is a top view thereof.

FIG. 7 is a bottom perspective view thereof.

FIG. 8 is a top perspective view of a bowl assembly with the handle extended, according to an embodiment of the present invention.

FIG. 9 is a bottom perspective view thereof.

FIG. 10 is a side view thereof (opposing side is mirror image).

FIG. 11 is a cut away side view showing the inside thereof.

FIG. 12 is a side view thereof (opposing side is mirror image).

FIG. 13 is a top view thereof.

FIG. 14 is a bottom perspective view thereof.

FIG. 15 is a top perspective view of a bowl assembly with the handle removed, according to an embodiment of the present invention.

FIG. 16 is a side view thereof (opposing side is mirror image).

FIG. 17 is a bottom perspective view thereof.

FIG. 18 is a front view of a handle removed from the bowl assembly according to an embodiment of the present invention.

FIG. 19 is a side view thereof.

FIG. 20 is a top perspective view thereof.

FIG. 21 is a top perspective view of a bowl assembly according to an embodiment of the present invention.

FIG. 22 is a bottom perspective view thereof.

FIG. 23 is a side view thereof (opposing side is mirror image).

FIG. 24 is a cut away side view showing the inside thereof.

FIG. 25 is a side view thereof (opposing side is mirror image).

FIG. 26 is a top view thereof.

FIG. 27 is a bottom perspective view thereof.

FIG. 28 is a top perspective view of a bowl assembly, according to an embodiment of the present invention.

FIG. 29 is a bottom perspective view thereof.

FIG. 30 is a side view thereof (opposing side is mirror image).

FIG. 31 is a cut away side view showing the inside thereof.

FIG. 32 is a side view thereof (opposing side is mirror image).

FIG. 33 is a top view thereof.

FIG. 34 is a bottom perspective view thereof.

### DETAILED DESCRIPTION OF THE INVENTION

In order that the invention herein described may be fully understood, the following detailed description is set forth.

Unless defined otherwise, all technical and scientific terms used herein have the same meaning as those commonly understood by one of ordinary skill in the art to which this invention belongs. Although methods and materials similar or equivalent to those described herein can be used in the practice or testing of the present invention, suitable methods and materials are described below. The materials, methods and examples are illustrative only, and are not intended to be limiting. All publications, patents and other documents mentioned herein are incorporated by reference in their entirety.

Throughout this specification, the word “comprise” or variations such as “comprises” or “comprising” will be understood to imply the inclusion of a stated integer or groups of integers but not the exclusion of any other integer or group of integers.

Throughout the description, where bowl assemblies are described as having, including, or comprising specific components, it is contemplated that assemblies of the present invention also consist essentially of or consist of the recited components.

In the detailed description, where an element or component is said to be included in and/or selected from a list of recited elements or components, it should be understood that the element or component can be anyone of the recited elements or components, or the element or component can be selected from a group consisting of two or more of the recited elements or components. Further, it should be understood that elements and/or features of a bowl assembly described herein can be combined in a variety of ways without departing from the spirit and scope of the present invention, whether explicit or implicit herein.

The use of the terms “include,” “includes,” “including,” “have,” “has,” or “having” should be generally understood as open-ended and non-limiting unless specifically stated otherwise.

The use of the singular herein includes the plural (and vice versa) unless specifically stated otherwise.

The term “a” or “an” may mean more than one of an item.

The terms “and” and “or” may refer to either the conjunctive or disjunctive and mean “and/or”.

The term “about” means within plus or minus 10% of a stated value. For example, “about 100” would refer to any number between 90 and 110.

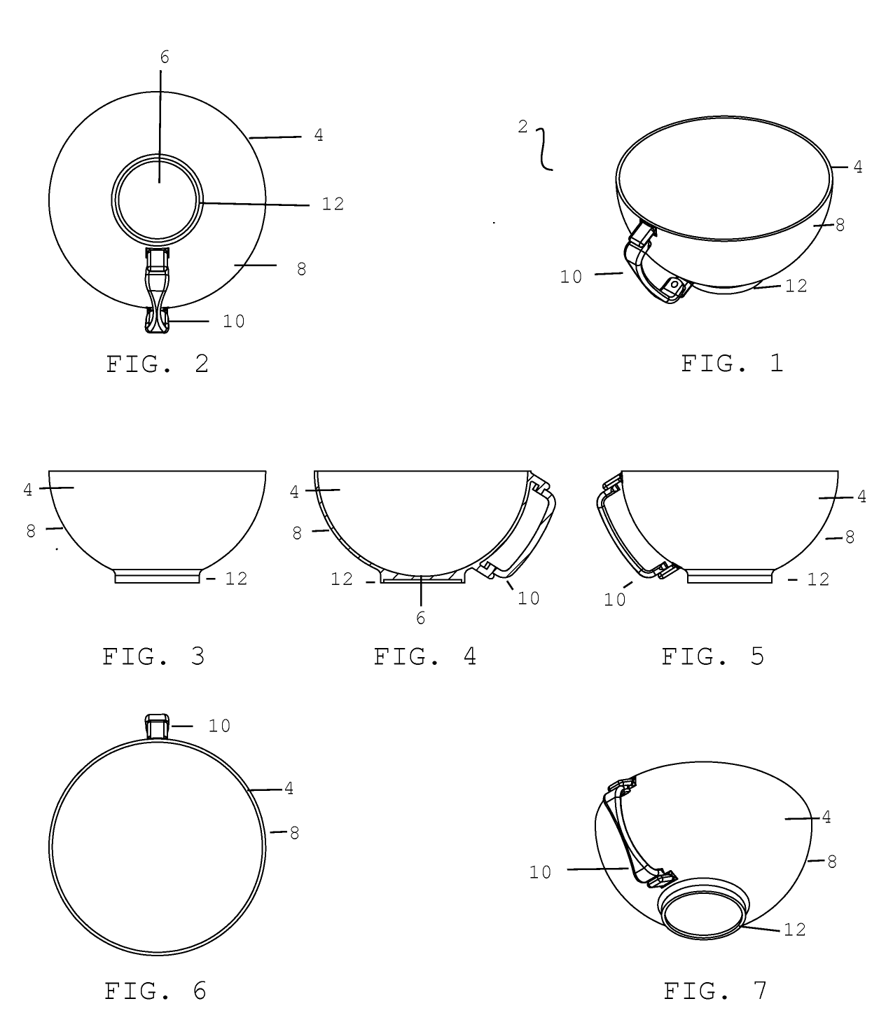

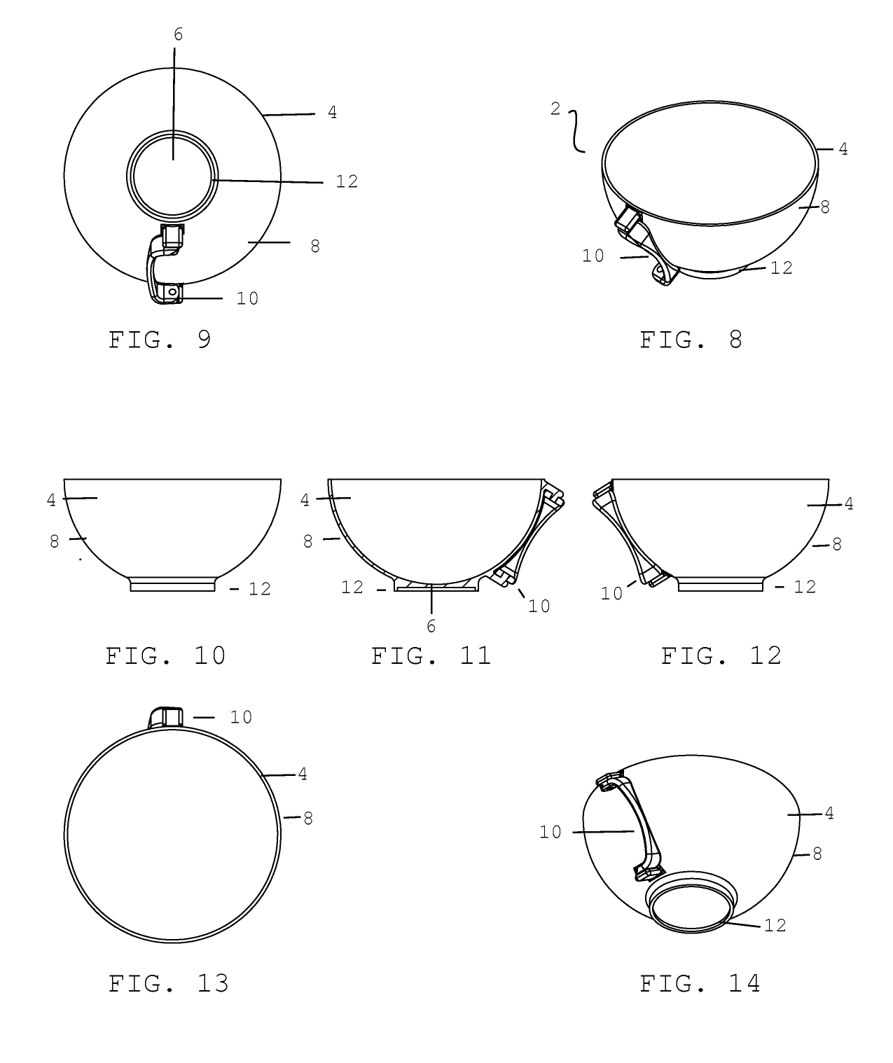

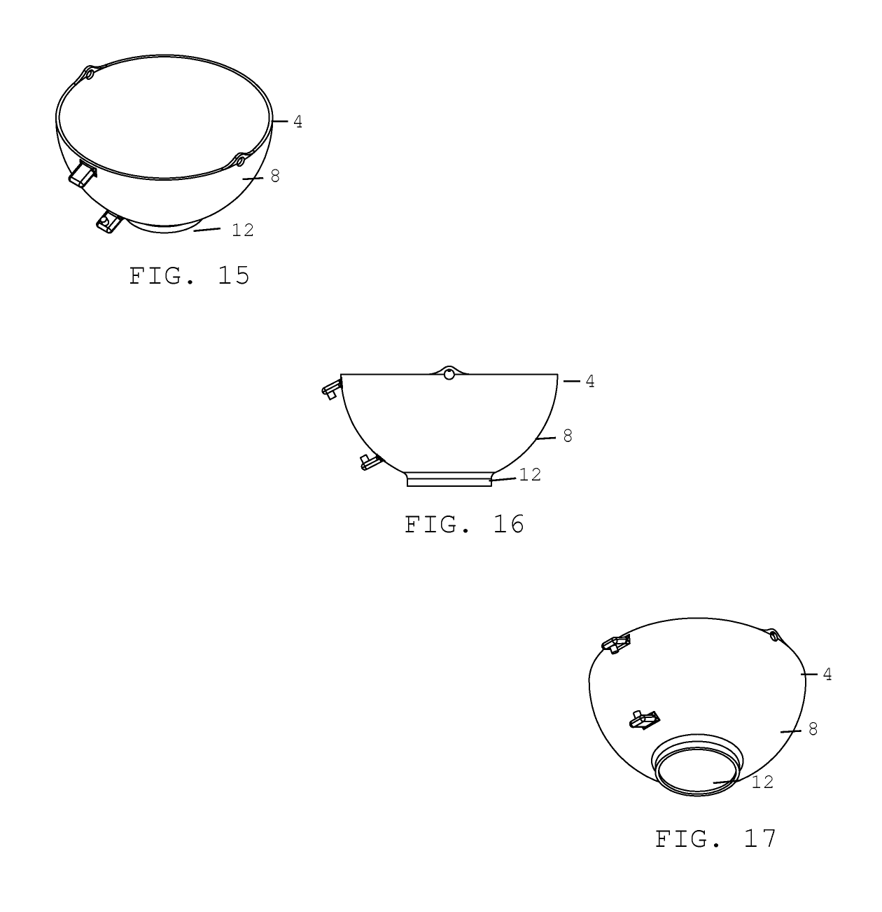

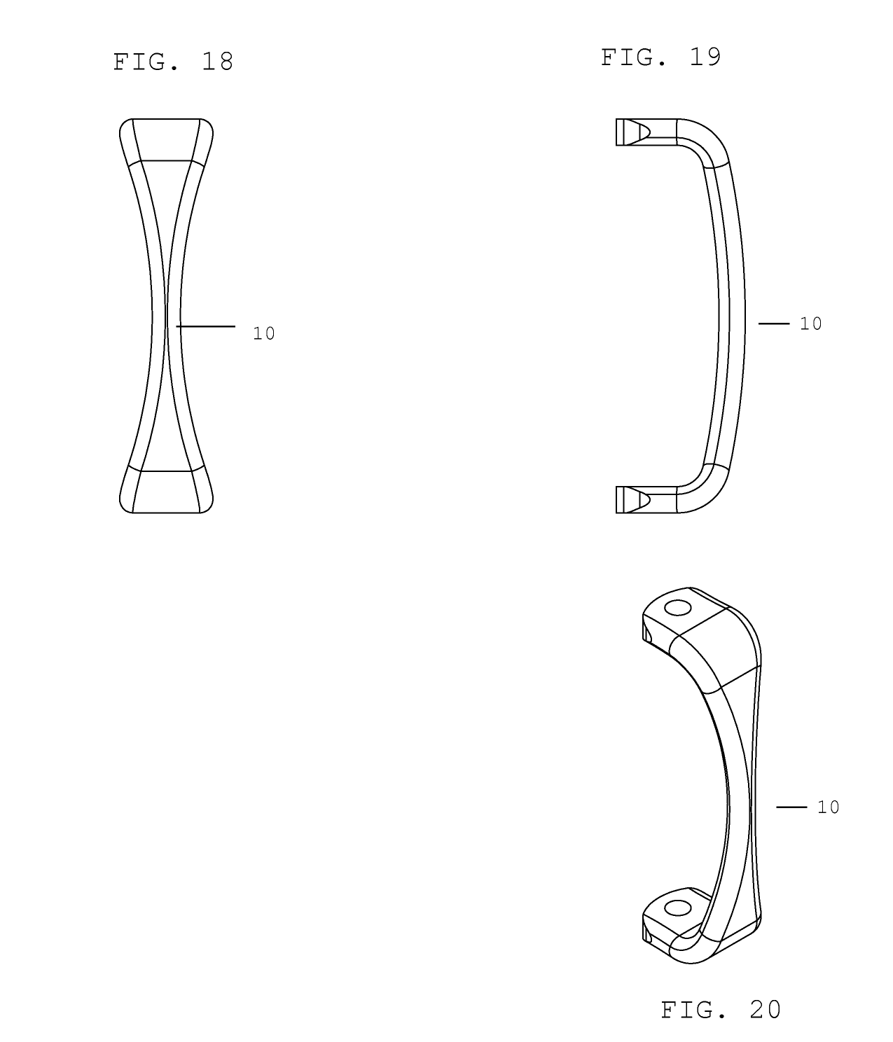

The present invention provides a bowl assembly with a substantially vertical handle that can be extended from, retracted towards, or detached from, the bowl assembly. As shown in FIGS. 1-14, bowl assembly 2 comprises a mixing bowl 4 having a bottom wall 6 and a peripheral wall 8; and a substantially vertical handle 10. The handle 10 is retractably and releasably attached to the outside of the peripheral wall 8. The handle 10 may be extended (as shown in FIGS. 1-7), retracted against the side wall of the mixing bowl (as shown in FIGS. 8-14), or released from the mixing bowl (FIGS. 15-18), depending on whether the bowl is to be handled, stored or stacked with other bowl assemblies.

In general, and as used herein, the mixing bowl of the present invention is shaped generally semi-spherical or nearly so. It has smooth peripheral and bottom walls and a surface that provides minimal resistance to sliding or slipping movements of the mixing bowl over a surface, such as a countertop. In some embodiments, the mixing bowl has a base 12.

The handle used in the bowl assemblies of the present invention may have any shape. Preferably, the handle is ergonomically shaped and allows a user to easily grasp the handle and move the bowl assembly. Even more preferably, the handle is shaped to maximize stacking of multiple bowl assemblies. FIGS. 19-21 show preferred handles of the present invention.

The present invention also provides a bowl assembly with an integrated scraper member. As shown in FIGS. 15-21, the bowl assembly 14 comprises a mixing bowl 16 having a bottom wall 6 and a peripheral wall 8. The peripheral wall 8 has two diametrically opposed apertures 18, 20. The bowl assembly also has a scraper member 22 having an edge shaped to substantially conform to the interior shape of the mixing bowl and having an outwardly extending post 24, 26 at each end of the scraper member, the upper portion of which extends through apertures 18 or 20. The scraper member 22 is capable of extending across substantially the entire interior dimension of the mixing bowl. A knob 28 is rotatably mounted to each post (24, 26). In operation, knob 28 can be turned clockwise and counter clockwise to, in turn, rotate the scraper member 22 in similar directions.

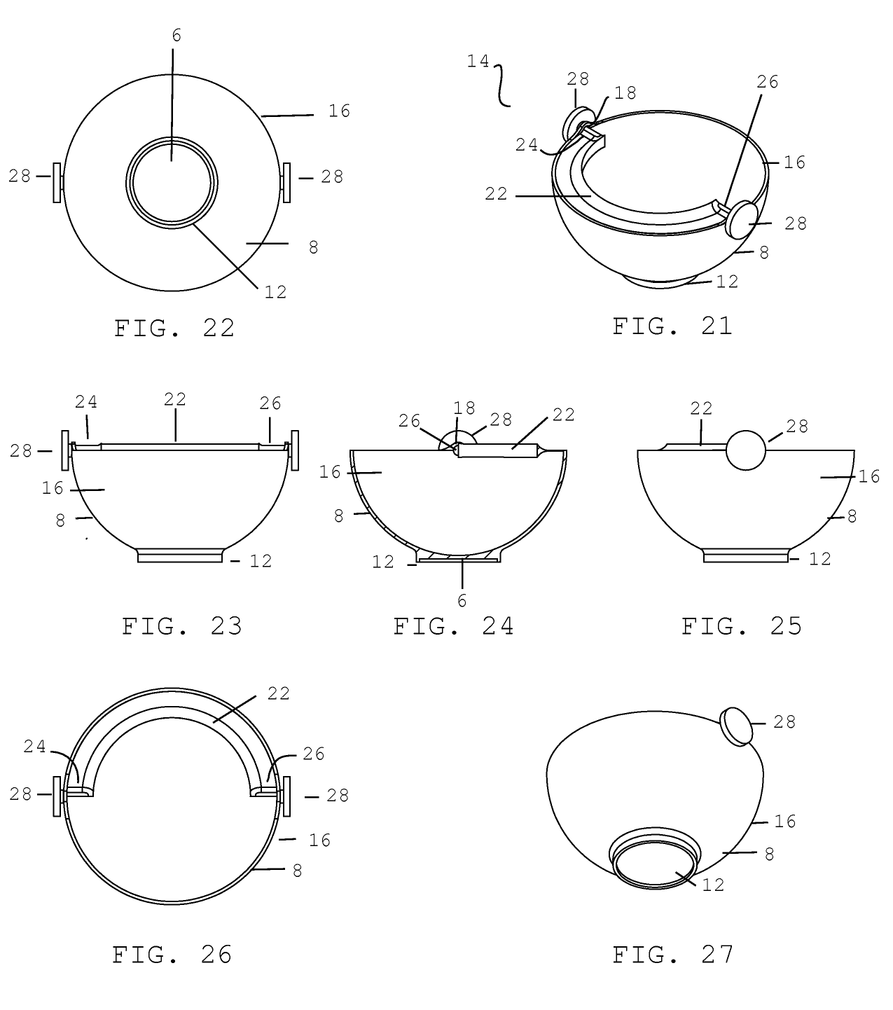

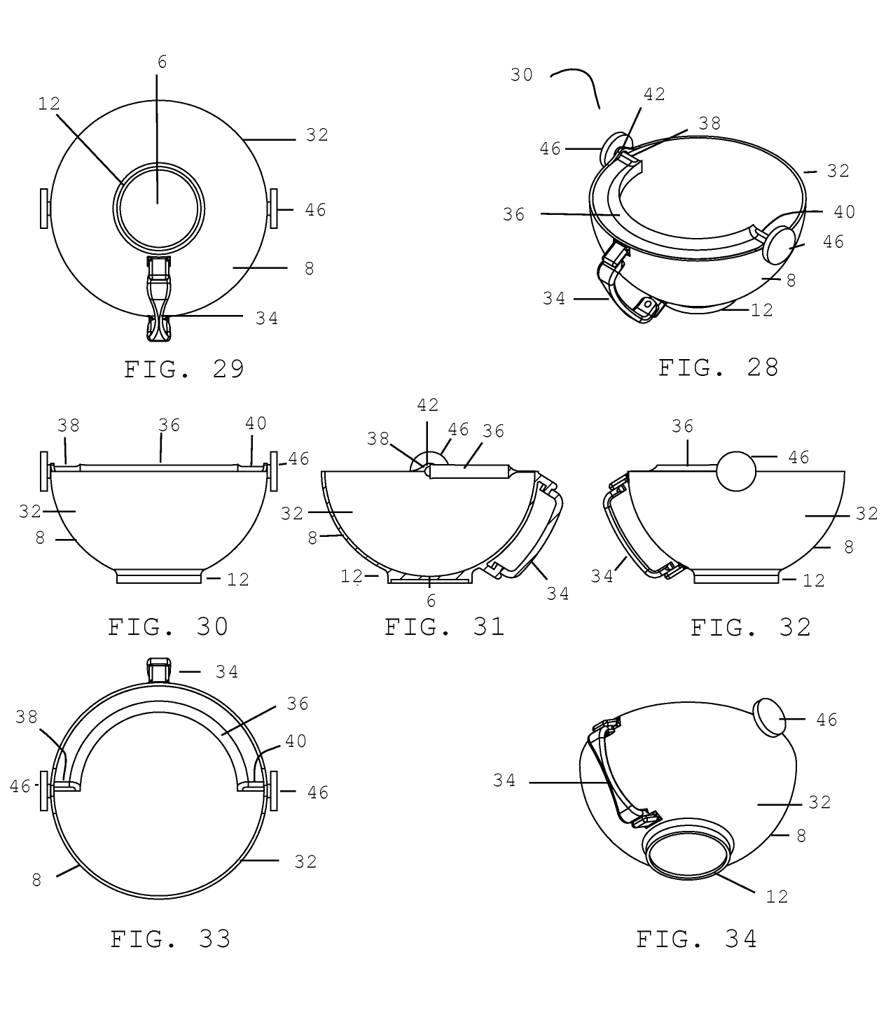

The present invention further provides a bowl assembly with a substantially vertical handle and an integrated scraper member. As shown in FIGS. 22-28, the bowl assembly 30 comprises a mixing bowl 32 having a bottom wall 6 and a peripheral wall 8. The mixing bowl 32 also has a substantially vertical handle 34 that is retractably and releasably attached to the outside of the peripheral wall 8. The mixing bowl has a scraper member 36 having an edge shaped to substantially conform to the interior shape of the mixing bowl and having an outwardly extending post 38, 40 at each end of the scraper member the upper portion of which extends through the apertures 42 or 44. The scraper member 36 is capable of extending across substantially the entire interior dimension of the mixing bowl. A knob 46 is rotatably mounted to each post (36, 38).

In alternate embodiments, the present invention provides a bowl assembly with an integrated scraper and a motor means for rotation thereof. In particular, the bowl assembly comprises a mixing bowl having a bottom wall and a peripheral wall, a scraper member, and a motor means. The peripheral wall has two diametrically opposed apertures. The scraper member has an edge shaped to substantially conform to the interior shape of the mixing bowl and has an outwardly extending post at each end. The scraper member is capable of extending across substantially the entire interior dimension of the mixing bowl. The upper portion of each post extends through the aperture and is coupled to the motor means to rotate the scraper member.

In alternate embodiments, the present invention provides a bowl assembly with a substantially vertical handle, an integrated scraper and a motor means for rotation thereof. In particular, the bowl assembly comprises a mixing bowl having a bottom wall and a peripheral wall, a substantially vertical handle, a scraper member, and a motor means. The handle is retractably and releasably attached to the outside of the peripheral wall. The peripheral wall has two diametrically opposed apertures. The scraper member has an edge shaped to substantially conform to the interior shape of the mixing bowl and has an outwardly extending post at each end, the upper portion of which extends through the aperture and is coupled to the motor means to rotate the scraper member. The scraper member is capable of extending across substantially the entire interior dimension of the mixing bowl.

In some embodiments, the knob is releasably mounted to each post. In other embodiments, the knob is mounted to each post via glue.

In some embodiments, the knob is substantially circular in shape. In other embodiments, the knob is ergonomically shaped.

In some embodiments, the motor means is rigidly attached to the post of the scraper member. In other embodiments, the motor means is coupled to the post of the scraper member through gears.

In some embodiments, the aperture is circular in shape.

In some embodiments, the post is circular in shape.

In some embodiments, the peripheral wall has a vertical lip to position the scraper member within the interior of the mixing bowl.

In some embodiments, the bowl assembly further comprises a lid.

In some embodiments, the mixing bowl comprises a resilient material.

In some embodiments, the handle comprises a resilient material.

In some embodiments, the scraper member comprises a resilient material.

In some embodiments, the knob comprises a resilient material.

In some embodiments, the resilient material is selected from the group consisting of metal, plastic and glass. In preferred embodiments, the resilient material is plastic.

While particular materials, formulations, operational sequences, process parameters, and end products have been set forth to describe this invention, they are not intended to be limiting. Rather, it should be noted by those ordinarily skilled in the art that the written disclosures are exemplary only and that various other alternatives, adaptations, and modifications may be made within the scope of the present invention. Accordingly, the present invention is not limited to the specific embodiments illustrated herein, but is limited only by the following claims.

What is claimed is:

1. A bowl assembly comprising:
(a) a mixing bowl having a bottom wall and a peripheral wall; and
(b) a substantially vertical handle, wherein the handle is retractably and releasably attached to the outside of the peripheral wall.

2. A bowl assembly comprising:
(a) a mixing bowl having a bottom wall and a peripheral wall, wherein the peripheral wall has two diametrically opposed apertures;
(b) a scraper member having an edge shaped to substantially conform to the interior shape of the mixing bowl and having an outwardly extending post at each end of the scraper member, the upper portion of which extends through the aperture;
wherein the scraper member is capable of extending across substantially the entire interior dimension of the mixing bowl; and
(c) a knob rotatably mounted to each post.

3. The bowl assembly according to claim 1, further comprising:
(c) the peripheral wall of the mixing bowl has two diametrically opposed apertures;
(d) a scraper member having an edge shaped to substantially conform to the interior shape of the mixing bowl and having an outwardly extending post at each end of the scraper member, the upper portion of which extends through the aperture;
wherein the scraper member is capable of extending across substantially the entire interior dimension of the mixing bowl; and
(e) a knob rotatably mounted to each post.

4. A bowl assembly comprising:
(a) a mixing bowl having a bottom wall and a peripheral wall, wherein the peripheral wall has two diametrically opposed apertures;
(b) a scraper member having an edge shaped to substantially conform to the interior shape of the mixing bowl and having an outwardly extending post at each end of the scraper member, the upper portion of which extends through the aperture;
wherein the scraper member is capable of extending across substantially the entire interior dimension of the mixing bowl; and
(c) a motor means coupled to the post of the scraper member for rotation of the scraper member.

5. The bowl assembly according to claim 1, further comprising:
(c) the peripheral wall of the mixing bowl has two diametrically opposed apertures;
(d) a scraper member having an edge shaped to substantially conform to the interior shape of the mixing bowl and having an outwardly extending post at each end of the scraper member, the upper portion of which extends through the aperture;
wherein the scraper member is capable of extending across substantially the entire interior dimension of the mixing bowl; and
(e) a motor means coupled to the post of the scraper member for rotation of the scraper member.

6. The bowl assembly according to claim 2 or 3, wherein the knob is releasably mounted to each post or is mounted to each post via glue.

7. The bowl assembly according to claim 4 or 5, wherein the motor means is rigidly attached to the post of the scraper member or is coupled to the post of the scraper member through gears.

8. The bowl assembly according to claim 2 or 4, wherein the peripheral wall has a vertical lip to position the scraper member within the interior of the mixing bowl.

9. The bowl assembly according to any of claim 1, 2 or 4, further comprising a lid.

10. The bowl assembly according to any of claim 1, 2 or 4, wherein one or more members selected from the group consisting of the mixing bowl, handle, scraper member and knob comprise a resilient material.

11. The bowl assembly according to claim 10, wherein the resilient material is selected from the group consisting of metal, plastic and glass.
